(19) United States
(12) Patent Application Publication
(10) Pub. No.: US 2016/0066045 A1
(43) Pub. Date: Mar. 3, 2016

(54) METHOD, ELECTRONIC DEVICE, AND COMPUTER PROGRAM PRODUCT

(71) Applicants: Kabushiki Kaisha Toshiba, Tokyo (JP); Toshiba Lifestyle Products & Services Corporation, Tokyo (JP)

(72) Inventors: Masahiko OJIMA, Ome Tokyo (JP); Shikyo OHASHI, Hino Tokyo (JP); Tomonori SAKAGUCHI, Ome Tokyo (JP); Munehiro TOKIKURA, Kawasaki Kanagawa (JP); Yosuke TAKAHASHI, Kokubunji Tokyo (JP); Toshifumi OHTAKE, Akiruno Tokyo (JP); Takuya KODA, Hino Tokyo (JP); Mitsuru SHIMBAYASHI, Nakano Tokyo (JP)

(21) Appl. No.: 14/603,216

(22) Filed: Jan. 22, 2015

(30) Foreign Application Priority Data
Aug. 29, 2014 (JP) 2014-176403

(51) Int. Cl. H04N 21/4722; H04N 21/482; H04N 21/81; H04N 21/478

(52) U.S. Cl. CPC H04N 21/4722; H04N 21/47815; H04N 21/4826; H04N 21/4828; H04N 21/8133

(57) ABSTRACT

According to one embodiment, a method includes: receiving first information and second information by an electronic device, the first information relating to first scenes in a first program and comprising information of one or more goods or services introduced in at least one of the first scenes, the second information relating to second scenes in a second program and comprising information of one or more goods or services introduced in at least one of the second scenes; receiving a first operation to specify a first good or a first service; and displaying information relating to one or more third scenes searched from the first scenes and the second scenes on a display in response to the first operation, the one or more third scenes introducing the specified first good or first service.

### CROSS-REFERENCE TO RELATED APPLICATIONS

This application is based upon and claims the benefit of priority from Japanese Patent Application No. 2014-176403, filed Aug. 29, 2014, the entire contents of which are incorporated herein by reference.

### FIELD

Embodiments described herein relate generally to a method, an electronic device, and a computer program product.

### BACKGROUND

Conventionally, there has been known a technique for acquiring program information of a broadcast program by use of a cloud server, for example. Examples of the program information include information relating to scenes included in a program and information relating to goods (items) or services introduced in a program.

In the above technique, it is preferable that information relating to a program in which one or more items or services specified by a user has been introduced can be finely searched, for example, in scene units.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating a network configuration of a system comprising an information terminal according to an embodiment;

FIG. 2 is an exemplary block diagram illustrating an internal configuration of the information terminal in the embodiment;

FIG. 3 is an exemplary block diagram illustrating a functional configuration of an information processing program in the embodiment;

FIG. 4A is an exemplary diagram illustrating My selection screen displayed on the information terminal in the embodiment;

FIG. 4B is another exemplary diagram illustrating My selection screen displayed on the information terminal in the embodiment;

FIG. 5 is an exemplary diagram illustrating a result list of a keyword search displayed on the information terminal in the embodiment;

FIG. 6 is an exemplary diagram illustrating a scene list displayed on the information terminal in the embodiment;

FIG. 7 is another exemplary diagram illustrating the scene list displayed on the information terminal in the embodiment;

FIG. 8 is an exemplary diagram illustrating a scene detail screen displayed on the information terminal in the embodiment;

FIG. 9 is an exemplary diagram illustrating an item service detail screen displayed on the information terminal in the embodiment;

FIG. 10 is an exemplary diagram illustrating a program list for each genre displayed on the information terminal in the embodiment;

FIG. 11 is an exemplary diagram illustrating a selection edit screen displayed on the information terminal in the embodiment;

FIG. 12 is another exemplary diagram illustrating the selection edit screen displayed on the information terminal in the embodiment;

FIG. 13 is an exemplary diagram illustrating a keyword list displayed on the information terminal in the embodiment;

FIG. 14 is an exemplary diagram illustrating an item service list displayed on the information terminal in the embodiment;

FIG. 15 is an exemplary diagram illustrating a recorded program list displayed on the information terminal in the embodiment;

FIG. 16 is an exemplary diagram illustrating a checklist displayed on the information terminal in the embodiment;

FIG. 17 is an exemplary diagram illustrating a screen for adding bookmark information displayed on the information terminal in the embodiment;

FIG. 18 is an exemplary flowchart illustrating processing executed by the information terminal when the information processing program is started, in the embodiment;

FIG. 19 is an exemplary flowchart illustrating search processing executed by the information terminal in the embodiment;

FIG. 20 is an exemplary flowchart illustrating processing executed by the information terminal when the bookmark information is added, in the embodiment; and

FIG. 21 is an exemplary flowchart illustrating processing executed by the information terminal when scene information is registered in the checklist, in the embodiment.

### DETAILED DESCRIPTION

In general, according to one embodiment, a method comprises: receiving first information and second information by an electronic device, the first information relating to first scenes in a first program and comprising information of one or more goods or services introduced in at least one of the first scenes, the second information relating to second scenes in a second program and comprising information of one or more goods or services introduced in at least one of the second scenes; receiving a first operation to specify a first good or a first service; and displaying information relating to one or more third scenes searched from the first scenes and the second scenes on a display in response to the first operation, the one or more third scenes introducing the specified first good or first service.

An embodiment will now be described with reference to the accompanying drawings.

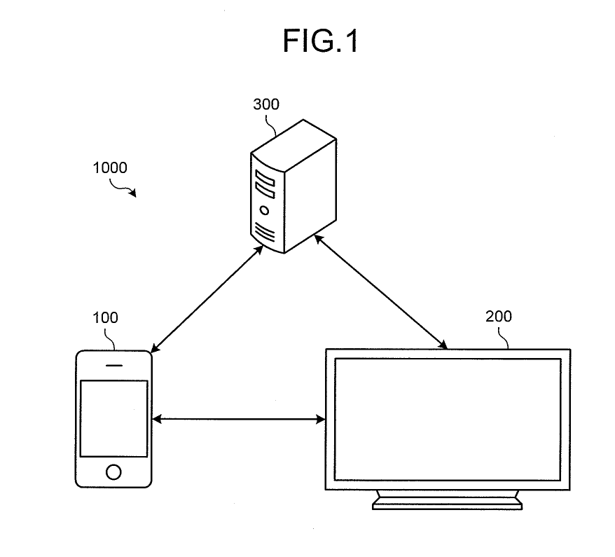

The following describes a network configuration of a system 1000 comprising an information terminal 100 according to the embodiment with reference to FIG. 1. The information terminal 100 is an example of “electronic device”.

As illustrated in FIG. 1, the system 1000 comprises the information terminal 100, a television device 200, and a program information server 300. The information terminal 100 is an information processor such as a smartphone, a tablet and the like. The television device 200 is a video image display device that is configured to automatically record a plurality of programs broadcast on a plurality of channels. In other words, the television device 200 has, what is called, a time shift machine function. The program information server 300 is a storage device that is configured to store therein program information relating to a plurality of programs.

Examples of the program information stored in the program information server 300 include scene information relating to each scene included in each program and item service information relating to an item or a service introduced in each scene. The scene information and the item service information are associated with each other and stored in the program information server 300. The scene information indicates a title, a description, a character, and a producer, for example, in each scene. The item service information indicates an item (a good), gourmet food (restaurant), an amusement facility, and an accommodation facility, for example, introduced in each scene. The program information is registered by, for example, an administrator of the program information server 300 after the broadcasting of a program.

As illustrated in FIG. 1, the information terminal 100, the television device 200, and the program information server 300 are connected so as to communicate with each other. More specifically, the information terminal 100 and the television device 200 are connected through a home network and the like. The information terminal 100 and the program information server 300 are connected through the Internet and the like. The television device 200 and the program information server 300 are connected through the Internet and the like.

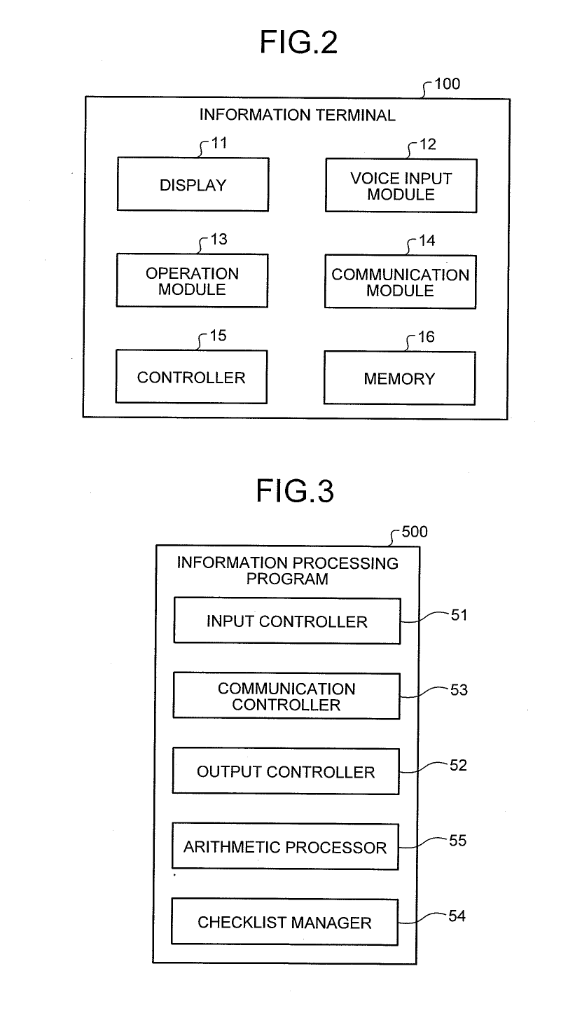

The following specifically describes an internal configuration of the information terminal 100 with reference to FIG. 2.

As illustrated in FIG. 2, the information terminal 100 mainly comprises a display 11, a voice input module 12, an operation module 13, a communication module 14, a controller 15, and a memory 16. The controller 15 is an example of “circuitry”.

The display 11 is a device that is configured to display video images including still images and moving images, such as a liquid crystal panel. The voice input module 12 is a device that is configured to receive a voice input from a user, such as a microphone. The operation module 13 is a device that is configured to receive an operation input from a user, such as a touch panel with the display 11. The communication module 14 is a communication interface that is used for communication with other devices (such as the program information server 300 and the television device 200).

The controller 15 comprises, for example, a central processing unit (CPU) that is configured to control each component of the information terminal 100 by executing various computer programs. The memory 16 comprises read-only memory (ROM) and random access memory (RAM), for example, and is configured to store therein various computer programs and various data used by the controller 15 for various types of arithmetic processing.

In the embodiment, the controller 15 is configured to execute an information processing program 500 as illustrated in FIG. 3, for example. The information processing program 500 has a modular configuration as described below.

As illustrated in FIG. 3, the information processing program 500 comprises an input controller 51, an output controller 52, a communication controller 53, a checklist manager 54, and an arithmetic processor 55. Each of these modules is generated on the RAM of the memory 16 as a result of the information processing program 500 read out from the ROM of the memory 16 and executed by the CPU of the controller 15.

The input controller 51 is configured to detect an input operation from a user through the voice input module 12 and the operation module 13. The output controller 52 is configured to control a video image output to the display 11 and a voice output to a speaker and the like, which are not illustrated.

The communication controller 53 is configured to control transmission and reception of various data through the communication module 14. For example, the communication controller 53 is configured to regularly acquire program information from the program information server 300. The checklist manager 54 is configured to manage a checklist (which will be described in detail below) stored in the memory 16. The arithmetic processor 55 is configured to perform various types of arithmetic processing and determination processing.

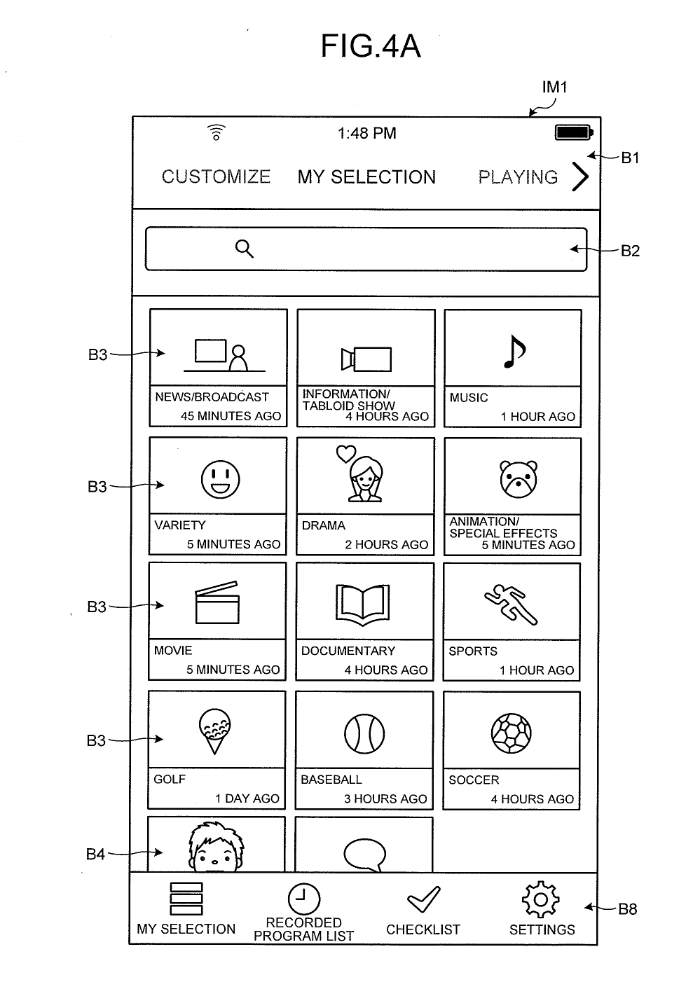

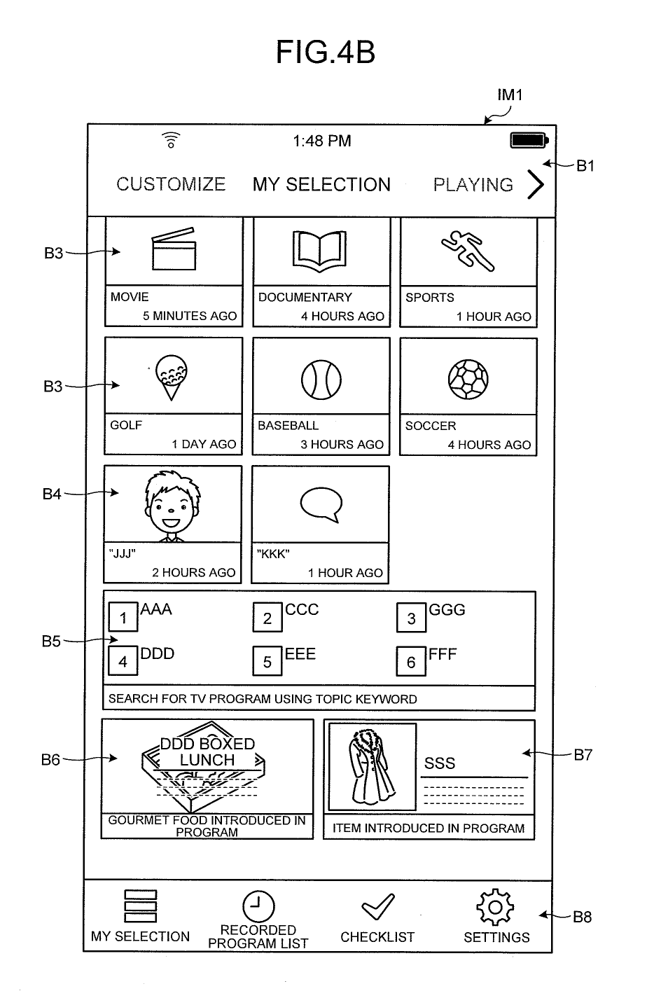

In the embodiment, when the information processing program 500 has been called, the output controller 52 is configured to display My selection screen IM1 (hereinafter referred to simply as the screen IM1) as illustrated in FIGS. 4A and 4B on the display 11. FIG. 4B illustrates the screen IM1 illustrated in FIG. 4A that is scrolled to the lower side.

As illustrated in FIGS. 4A and 4B, the screen IM1 comprises a title bar B1, a search bar B2, a plurality of selection buttons B3 to B7, and a tab bar B8. The tab bar B8 is fixedly displayed on the display 11 even if the displayed screen is switched due to various operations, which will be described below.

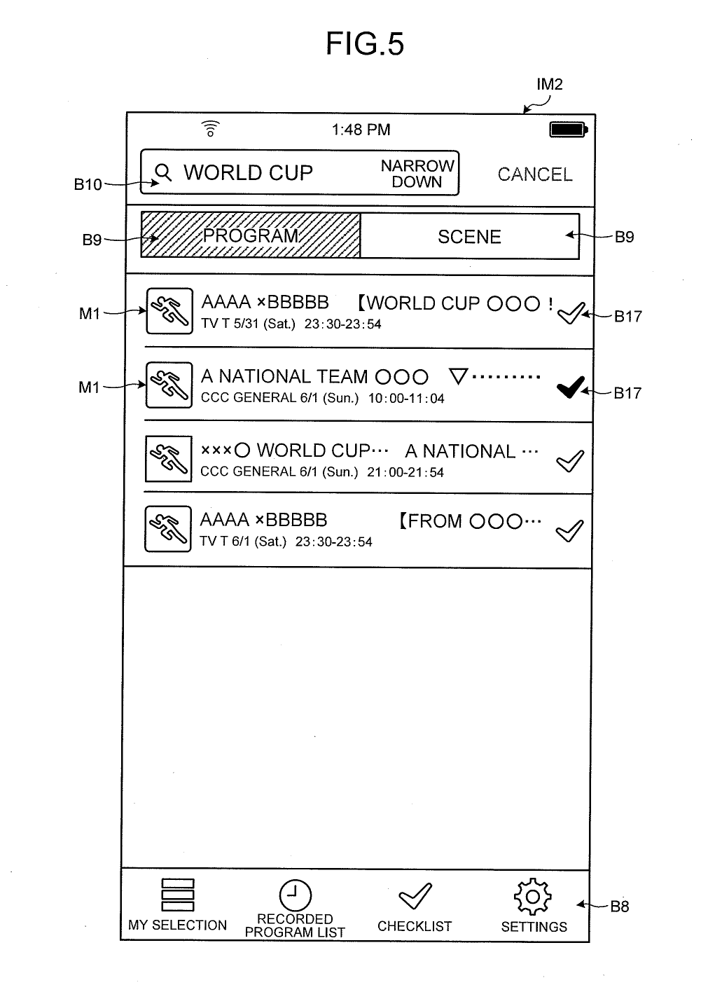

A keyword search with the search bar B2 in FIG. 4A will be described with reference to FIGS. 5 to 9. The keyword search is an operation for acquiring program information that matches or relates to a keyword input in the search bar B2 by use of a software keyboard and the like, from the program information server 300 so as to display the acquired program information on the display 11.

For example, when the input controller 51 detects that the keyword of “WORLD CUP” is input in the search bar B2 in FIG. 4A, the communication controller 53 acquires program information relating to programs, which match or relate to the keyword of “WORLD CUP”, from the program information server 300. The output controller 52 then displays a list of the program information acquired by the communication controller 53 on the display 11 as a result of the keyword search (see a screen IM2 in FIG. 5).

Here, FIG. 5 illustrates an example where the search results are displayed for each program. A user can switch the display of the search results in program units or in scene units by touching (selecting) a display switching button B9 on the screen IM2. In addition, a user can further narrow down the search results by touching the display of “NARROW DOWN” displayed in the search bar B10 on the screen IM2.

The screen IM2 in FIG. 5 illustrates an example where a plurality of programs as the search results are displayed in the order of broadcast times. However, in the embodiment, the programs as the search results are not necessarily displayed in the order of broadcast times. In the embodiment, the display style of a plurality of marks M1 displayed corresponding to the programs as the search results may be changed so as to identify whether each of the programs as the search results is recorded in the television device 200. For example, the mark M1 corresponding to the program that is recorded in the television device 200 may be displayed in a relatively bright state, whereas the mark M1 corresponding to the program that is not recorded in the television device 200 maybe displayed in a relatively dark state (displayed in gray-out).

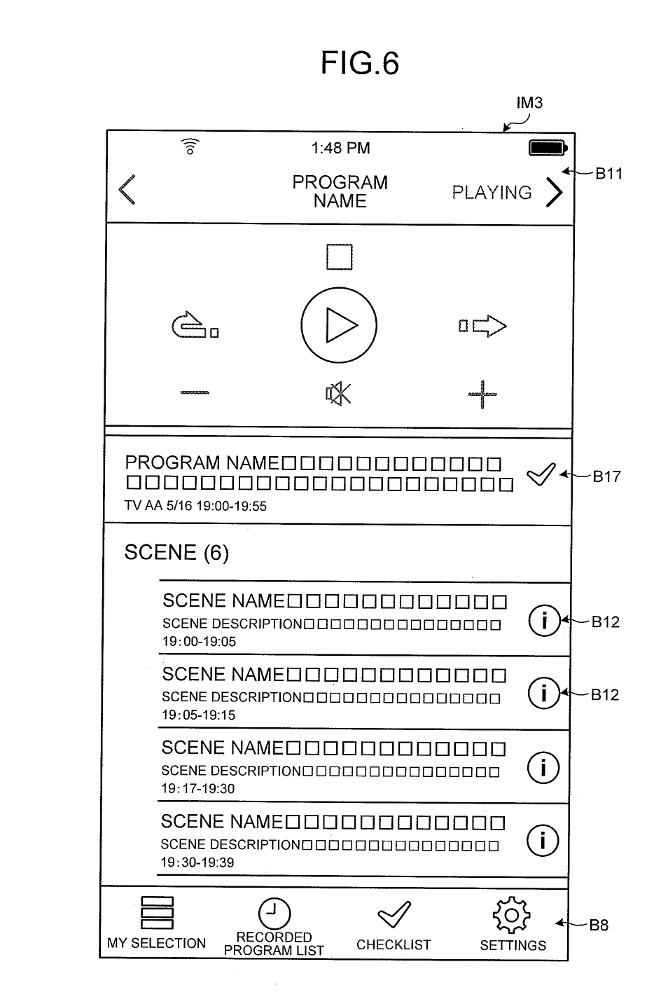

When the input controller 51 detects an operation of touching one of the programs displayed on the screen IM2 in FIG. 5, the output controller 52 displays a list of a plurality of pieces of scene information relating to a plurality of scenes included in the selected program on the display 11 (see a screen IM3 in FIG. 6). When a user touches one of the scenes displayed on the screen IM3 in FIG. 6, the selected scene is displayed and played on the television device 200. In other words, the information terminal 100 can be used as a remote controller for operating the television device 200 in the embodiment.

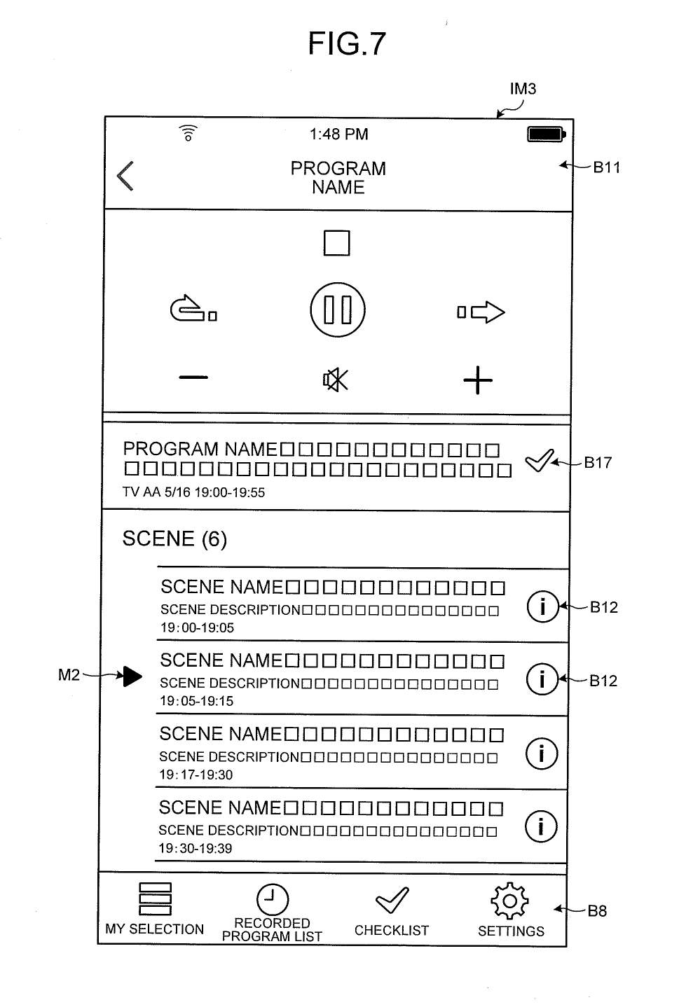

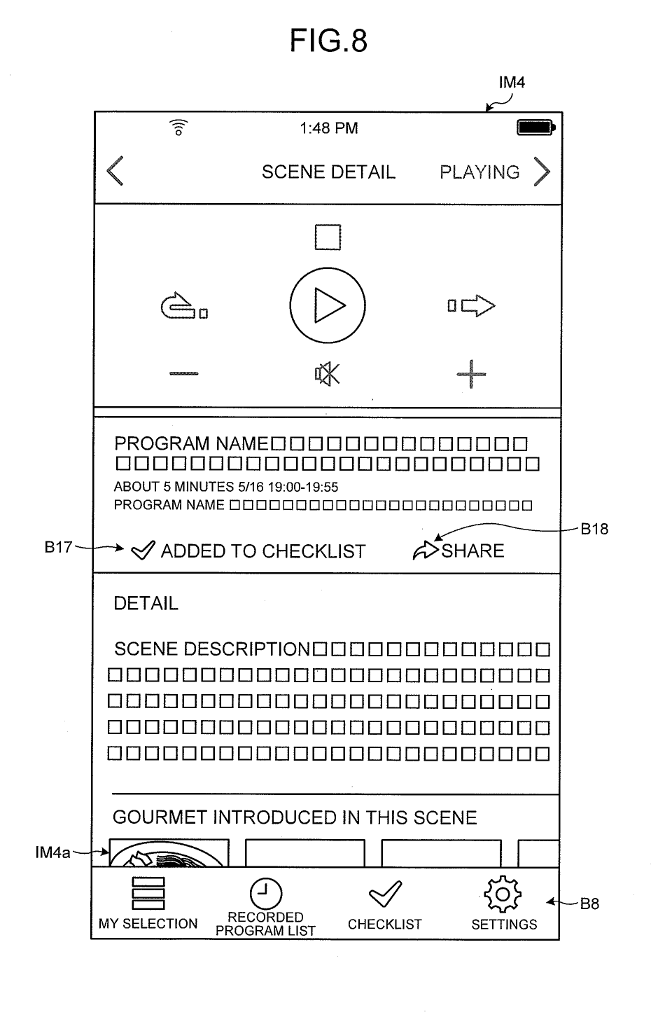

When the input controller 51 detects an operation of touching one of the scenes displayed on the screen IM3 in FIG. 6, the output controller 52 displays a mark M2 for clearly indicating that the selected scene is displayed and played on the television device 200 on the screen IM3 as illustrated in FIG. 7. The same screen as this screen IM3 is also displayed, for example, when the display of “Playing” displayed on the title bar B1 in FIGS. 4A and 4B and a title bar B11 in FIG. 6 is touched. In other words, in the embodiment, when selecting the display of “Playing”, a user can display a scene list of a program including the scene currently displayed and played on the television device 200 in the same display style as that of the screen IM3 in FIG. 7 on the display 11. There are title bars comprising the display of “Playing” in FIGS. 8, 9 and 13 to 16, which will be described below. Even if the display of “Playing” in these title bars is selected, the same scene list as that of the screen IM3 in FIG. 7 is displayed on the display 11.

When the input controller 51 detects an operation of touching a detail display button B12 displayed corresponding to each scene on the screen IM3 in FIG. 6 or 7, the output controller 52 displays a scene detail screen IM4 (hereinafter referred to simply as the screen IM4) as illustrated in FIG. 8 on the display 11.

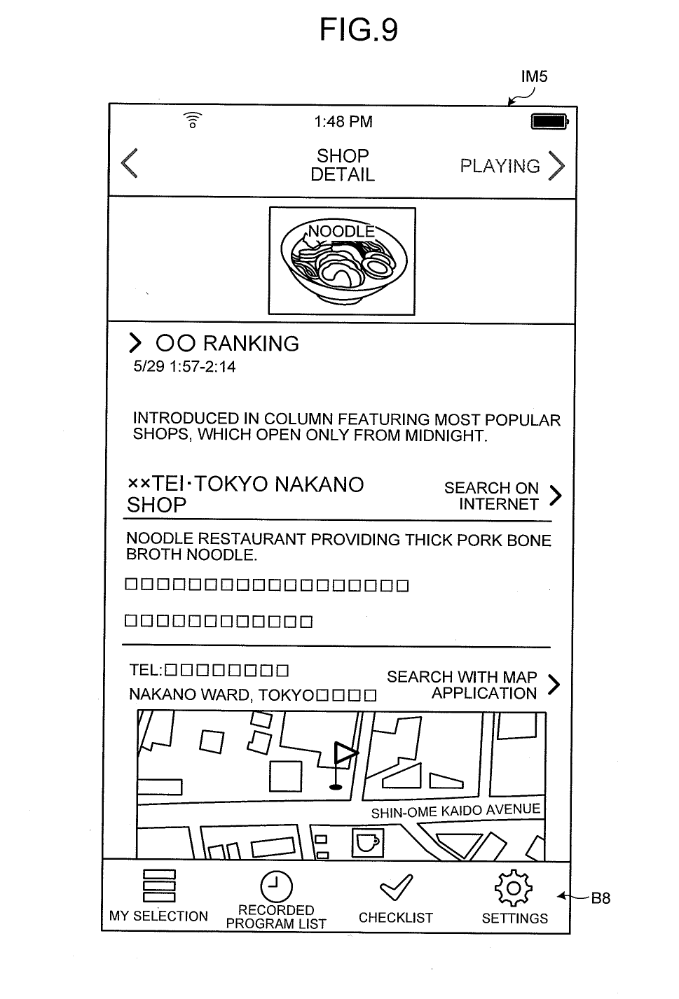

The screen IM4 in FIG. 8 displays scene information that relates to the scene corresponding to the detail display button B12 selected on the screen IM3 in FIG. 6 or 7, and item service information that corresponds to the scene information. When the input controller 51 detects an operation of touching an image IM4a corresponding to the item service information displayed on the screen IM4, the output controller 52 displays an item service detail screen IM5 (hereinafter referred to simply as the screen IM5) as illustrated in FIG. 9 on the display 11.

The screen IM5 in FIG. 9 displays the detail of the item service information corresponding to the image IM4a selected on the screen IM4 in FIG. 8. The screen IM5 in FIG. 9 displays, for example, a title and a broadcast time of a program in which an item or a service has been introduced, and a name, a description, and an address (map) of a shop providing the item or the service, as the detail of the item service information.

The screen IM5 in FIG. 9 displays “SEARCH ON INTERNET” next to a name of a shop. A user can start a browser installed in the information terminal 100 by touching the display of “SEARCH ON INTERNET” so that the information that matches or relates to the name of a shop displayed on the screen IM4 can be searched for on the Internet. The screen IM5 also displays “SEARCH WITH MAP APPLICATION” next to an address of a shop. A user can start the map application installed in the information terminal 100 by touching this display of “SEARCH WITH MAP APPLICATION” so that the map around the address of a shop displayed on the screen IM4 can be searched for with the map application.

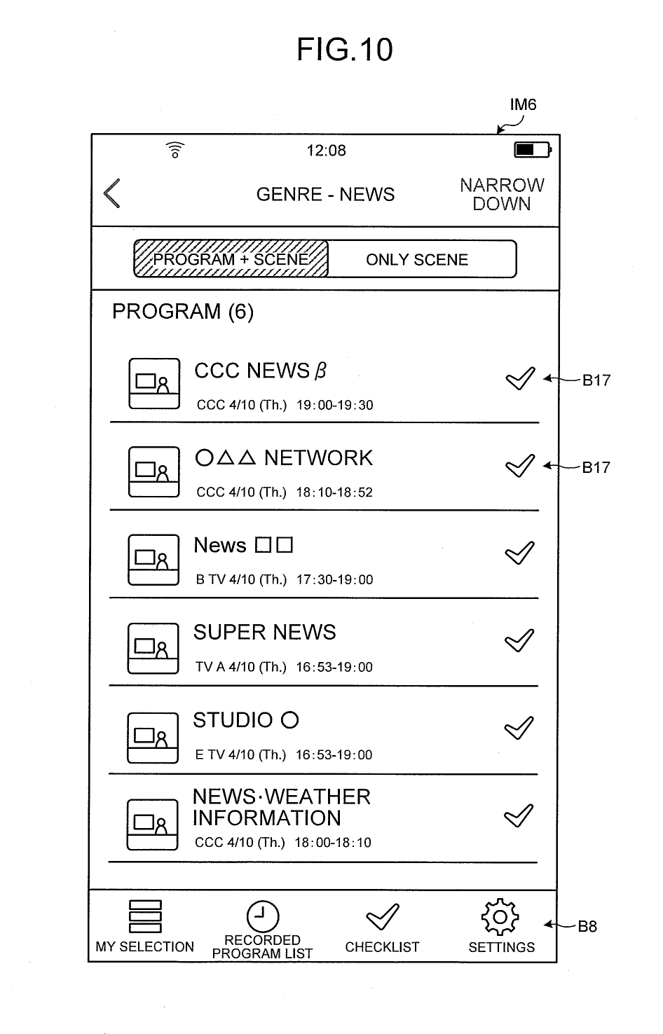

The following describes a selection search with the selection buttons B3 to B7 displayed on the screen IM1 in FIGS. 4A and 4B with reference to FIGS. 10 to 14.

The selection button B3 in FIGS. 4A and 4B is provided in plurality for each genre of the programs. When the input controller 51 detects an operation of touching one of these selection buttons B3, the communication controller 53 searches for and acquires program information of a program belonging to a genre matching the genre corresponding to the selected selection button B3, from the program information server 300. The output controller 52 displays a list of the program information acquired by the communication controller 53 as a program list for each genre on the display 11 (see a screen IM6 in FIG. 10). The screen IM6 in FIG. 10 displays a list of program information for a plurality of programs belonging to a genre of “NEWS” as an example.

The screen IM1 in FIG. 4B displays selection buttons B4 corresponding to keywords such as “JJJ” and “KKK” as well as the above-mentioned selection buttons B3. Each of the selection buttons B4 is a button for displaying a list of the program information including a keyword that match or relate to a keyword corresponding to the selection button B4. In other words, when the input controller 51 detects an operation of touching the selection button B4, the communication controller 53 searches for and acquires program information including a keyword that matches or relates to the keyword corresponding to the selected selection button B4, from the program information server 300. The output controller 52 displays a list of the program information acquired by the communication controller 53 in the same display style as that of the screen IM6 in FIG. 10 on the display 11.

A user can optionally set search conditions for the selection search. In other words, a user can optionally set selection buttons that correspond to any search conditions, to be displayed on the screen IM1 in FIGS. 4A and 4B. Each of the selection buttons hereinbefore is a button for displaying a list of the search results based on preset search conditions in the same display style as that of the screen IM6 in FIG. 10 on the display 11, and a button having the same function as that of the above-mentioned selection buttons B3 and B4.

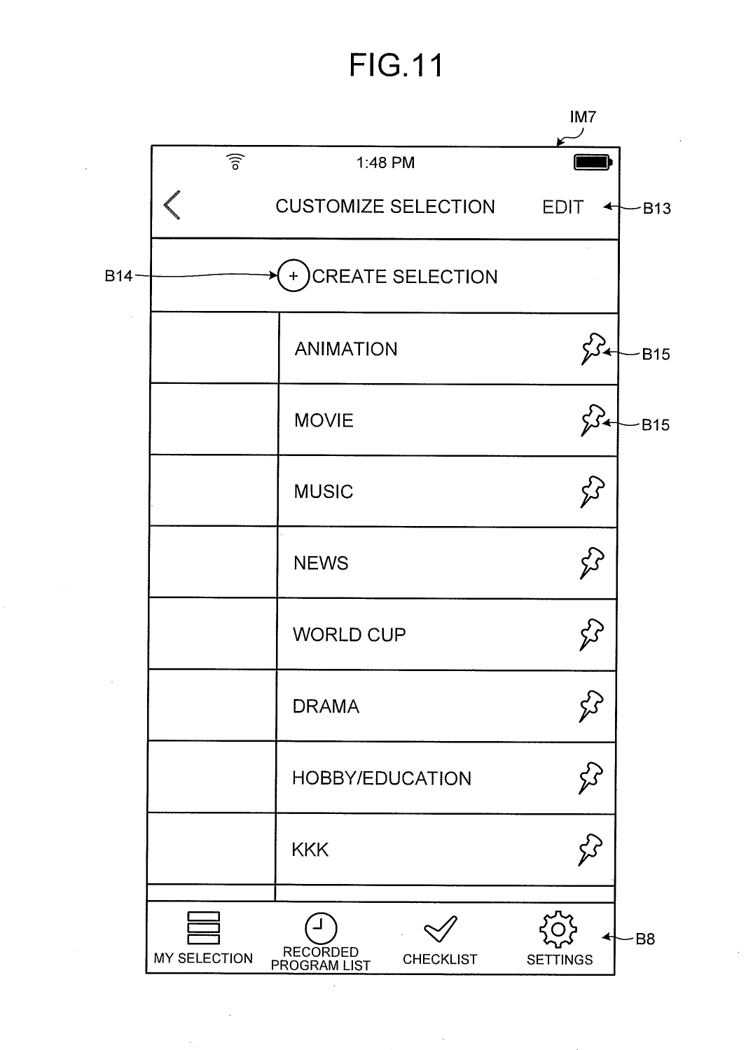

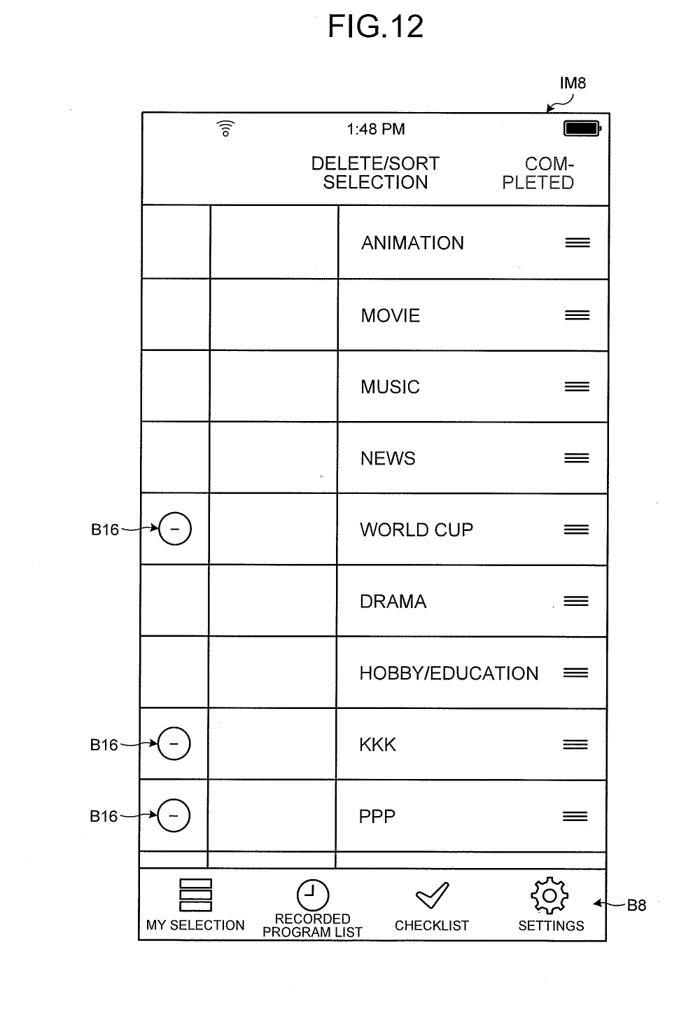

Specifically, a user can add and delete search conditions for the selection search by performing predetermined operations on selection edit screens IM7 and IM8 (hereinafter referred to simply as the screens IM7 and IM8) in FIGS. 11 and 12, respectively. The screen IM7 in FIG. 11 is a screen displayed on the display 11 when the character string of “CUSTOMIZE” displayed on the title bar B1 in FIGS. 4A and 4B is selected. The screen IM8 in FIG. 12 is displayed on the display 11 when the character string of “EDIT” displayed on the title bar B13 on the screen IM7 in FIG. 11 is selected.

For example, when a user selects a button B14 of “CREATE SELECTION” displayed on the screen IM7 in FIG. 11 and inputs a new search condition, a new selection button corresponding to the input search condition can be additionally displayed on the screen IM1 in FIGS. 4A and 4B. The screen IM7 in FIG. 11 displays a list of genres such as Animation and Movie, and keywords such as “WORLD CUP” and “KKK”, for example. The button B15 displayed corresponding to each genre and keyword can be used for switching whether to display the selection button corresponding to each genre and keyword in FIG. 11 on the screen IM1 in FIGS. 4A and 4B.

Moreover, a user can delete the search conditions set in the past by operating the buttons B16 displayed on the screen IM8 in FIG. 12. In the embodiment, the buttons B16 may be configured not to be displayed for the search conditions preset by default, and to be displayed for the search conditions created by a user. This configuration makes the search conditions preset by default undeletable, and makes only the search conditions created by a user deletable. For example, the screen IM8 in FIG. 12 displays the buttons B16 only for the keywords of “WORLD CUP”, “KKK”, and “PPP” created by a user.

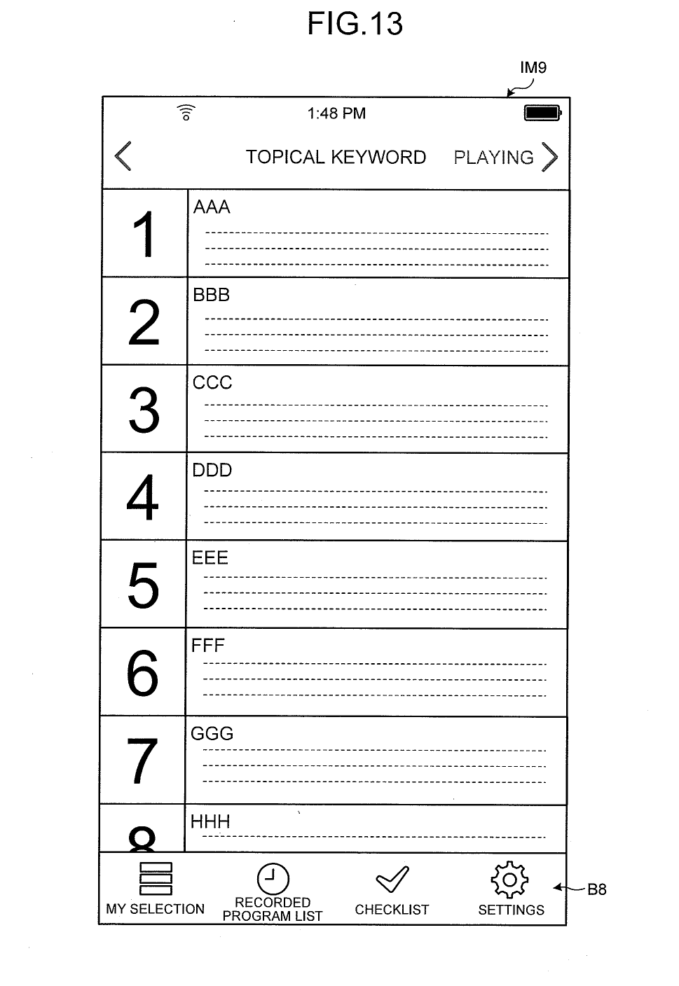

A screen IM9 in FIG. 13 indicates a list of keywords displayed on the display 11 when the selection button B5 in FIG. 4B is selected. This screen IM9 displays a list of popular keywords that are frequently set by a user as search objects, in the descending order of setting frequency. When a user selects one of the keywords displayed as a list on the screen IM9, program information including a keyword that matches or relates to the selected keyword is displayed on the display 11 in the same display style as that of the screen IM2 in FIG. 5.

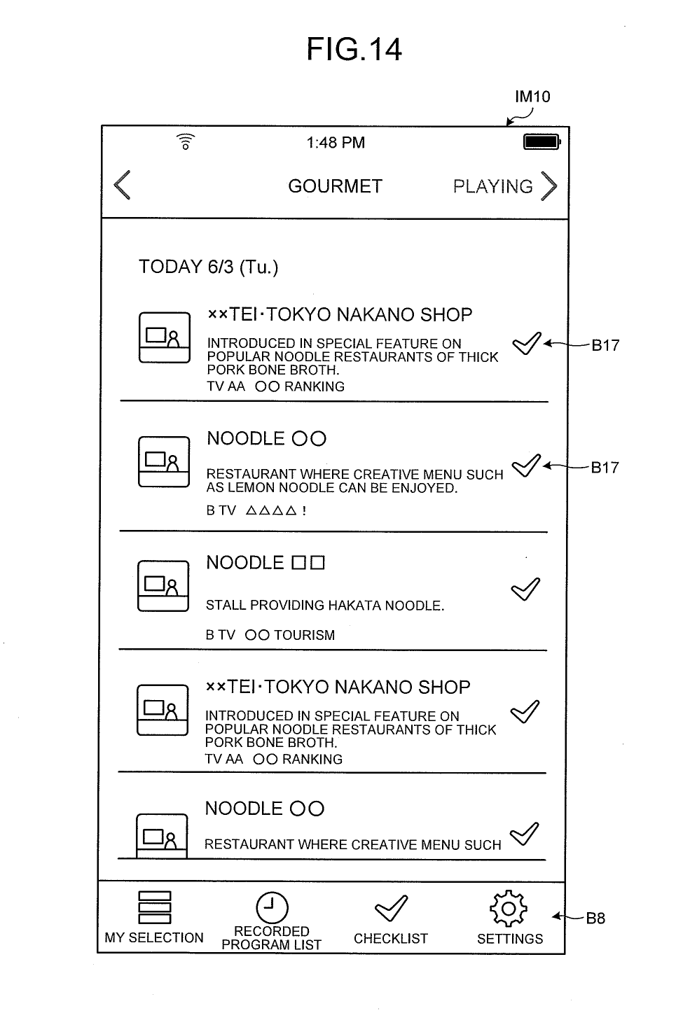

A screen IM10 in FIG. 14 indicates a list of items or services displayed on the display 11 when the selection button B6 in FIG. 4B is selected. This screen IM10 displays a list of information of gourmet food (shop information of restaurants) introduced in a program in the newer order of introduced dates. When a user selects one of the pieces of shop information displayed as a list on the screen IM10, the detail of the selected shop information is displayed on the display 11 in the same display style as that of the screen IM5 in FIG. 9. In the embodiment, when the selection button B6 in FIG. 4B is selected, a list of information of the item introduced in a program is displayed on the display 11 in the same display style as that of the screen IM10 in FIG. 14.

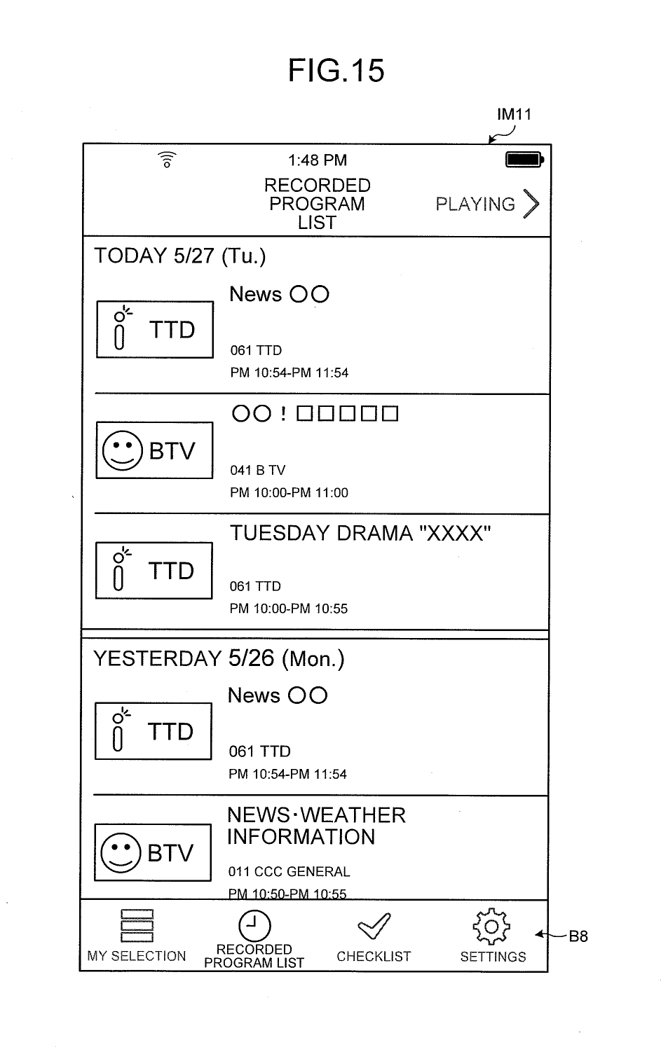

The following describes a recorded program list with reference to FIG. 15. The recorded program list indicates a list of programs recorded on the television device 200.

The screen IM11 in FIG. 15 is displayed on the display 11 when the “RECORDED PROGRAM LIST” part of the tab bar B8 is selected. When a user selects one of the programs displayed as a list on the screen IM11, program information of the selected program is displayed on the display 11 in the same display style as that of the screen IM3 in FIG. 6. FIG. 15 illustrates the screen IM11 that displays a list of the program recorded on the television device 200 in the newer order of broadcast dates as an example of the display manner of the recorded program list, but the order of displaying programs is not necessarily the newer order of broadcast dates, in the embodiment.

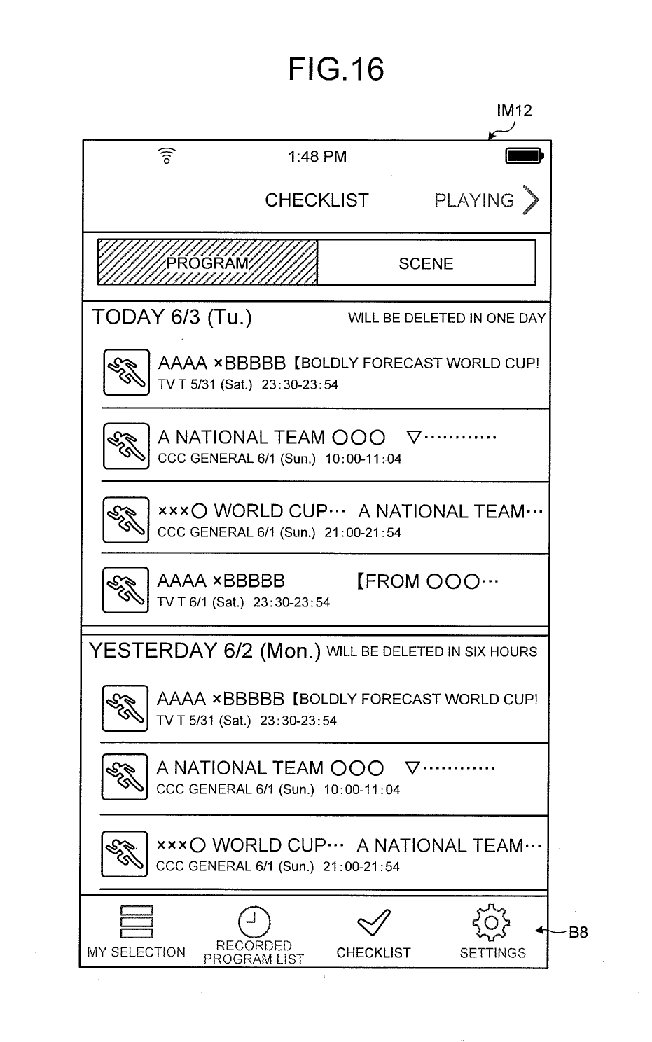

The following describes the checklist with reference to FIG. 16. The checklist indicates a list of information in which a user has been interested.

A screen IM12 in FIG. 16 illustrates a list of programs in which a user has been interested as an example of the checklist. This screen IM12 is displayed on the display 11 when the “CHECKLIST” part of the tab bar B8 is selected. When a user selects one of the programs displayed as a list on the screen IM12, program information of the selected program is displayed on the display 11 in the same display style as that of the screen IM3 in FIG. 6. In the embodiment, as illustrated in FIG. 16, the remaining time until when the program registered in the checklist is deleted from storage of the television device 200 may be displayed.

Examples of the methods for registering information in the checklist include a method by use of operating the buttons B17 in FIGS. 5 to 8, 10, and 14. In other words, when the input controller 51 detects an operation of touching the button B17 in FIGS. 5 to 8, 10, and 14, the communication controller 53 acquires program information of the program displayed correspondingly to the button B17 from the program information server 300. The checklist manager 54, then, registers the program information acquired by the communication controller 53 in the checklist within the memory 16.

In the embodiment, the checklist is configured to have the information in which a user has been interested registered not only in program units but also in scene units and in item or service units. In other words, in the embodiment, when a user touches the button B17 on the screen IM4 in FIG. 8, scene information of the scene displayed on the screen IM4 can be registered in the checklist. Also, when a user touches the button B17 on the screen IM10 in FIG. 14, item service information of the item or service displayed on the screen IM10 can be registered in the checklist. A button B18 in FIG. 8 is a button for sharing scene information of the scene displayed on the screen IM4 with other users by use of a social networking service (SNS) and the like.

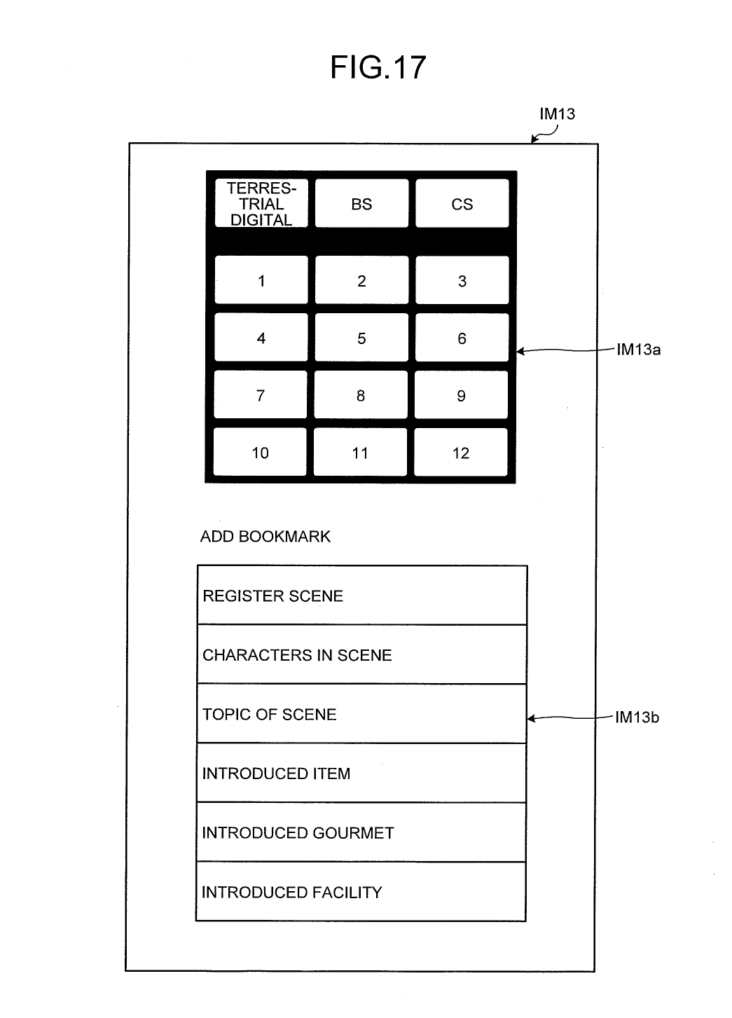

In the embodiment, examples of the methods for registering information in the checklist include a method by use of operating a screen IM13 in FIG. 17 other than the method by use of operating the above-mentioned buttons B17. This screen IM13 displays an image IM13a that comprises channel selection buttons for switching a channel of a program displayed and played on the television device 200, and an image IM13b for inputting bookmark information, which will be described below.

When a user touches the display of “REGISTER SCENE” on the image IM13b in FIG. 17, a scene of the program displayed and played on the television device 200 at the time of being performed the above-mentioned operation can be registered in the checklist.

When the program displayed and played at the time of operating the image IM13b in FIG. 17 is the recorded program which is a program recorded in the past, program information of the program must have already been stored in the program information server 300. Therefore, in this case, if the information terminal 100 is configured to regularly acquire the program information from the program information server 300, the checklist manager 54 can promptly register scene information of the scene specified by a user in the checklist based on the acquired program information.

On the other hand, when the program displayed and played at the time of operating the image IM13b in FIG. 17 is the currently broadcasting program, program information of the program cannot be yet stored in the program information server 300. Therefore, in this case, the arithmetic processor 55 temporarily stores a channel and a time (broadcast time) of the program displayed and played at the time of operating the image IM13b as bookmark information. The arithmetic processor 55 then regularly acquires the program information from the program information server 300 through the communication controller 53, and monitors whether scene information of the scene specified based on the channel and time stored as the bookmark information is acquired. When the scene information corresponding to the bookmark information is acquired from the program information server 300, the output controller 52 outputs an image or a voice, for example, for notifying a user of the acquisition of the scene information. The checklist manager 54 then registers the scene information acquired in this manner in the checklist.

The image IM13b in FIG. 17 comprises the display of “CHARACTORS IN SCENE”, “TOPIC OF SCENE”, “INTRODUCED ITEM”, “INTRODUCED GOURMET”, and “INTRODUCED FACILITY”, besides the display of “Register scene”. The display is provided for allowing a user to select information in which the user is interested out of the program displayed and played on the television device 200. Therefore, if the display selected by the user out of the above-mentioned display is stored, the kind of information in which the user is interested can be estimated and the information in which the user is interested can be provided to the user as recommended information later.

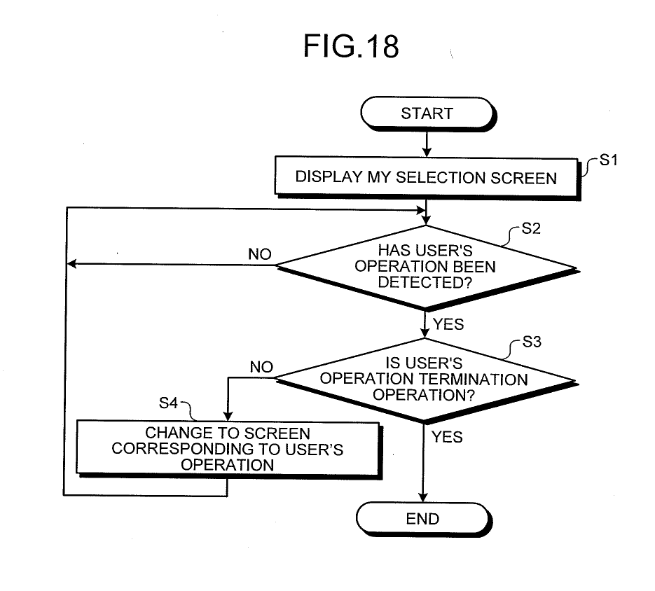

The following describes the processing executed by the information terminal 100 at the time of starting the information processing program 500 with reference to FIG. 18.

In the processing flow illustrated in FIG. 18, the output controller 52 displays My selection screen (screen IM1 in FIGS. 4A and 4B) on the display 11 at S1. Then the processing goes to S2.

At S2, the arithmetic processor 55 determines whether the input controller 51 has detected the operation of a user. The processing of S2 is repeated until the operation of a user is determined to have been detected. If the operation of a user is determined to have been detected at S2, the processing goes to S3.

At S3, the arithmetic processor 55 determines whether the operation of a user detected by the input controller 51 is a termination operation to terminate the information processing program 500. If the operation of a user is determined to be the termination operation at S3, the processing ends. If the operation of a user is determined not to be the termination operation at S3, for example, if the operation of a user is determined to be an operation to input a keyword in the search bar B2 in FIG. 4A, an operation to touch the selection buttons B3 to B7, or the like, the processing goes to S4.

At S4, the output controller 52 changes the screen displayed on the display 11 to a screen corresponding to the operation of a user. For example, if the input controller 51 detects an operation of touching the selection button B3 when the screen IM1 in FIGS. 4A and 4B is displayed, the output controller 52 changes the screen displayed on the display 11 from the screen IM1 to the screen IM6 in FIG. 10. Then the processing returns to S2.

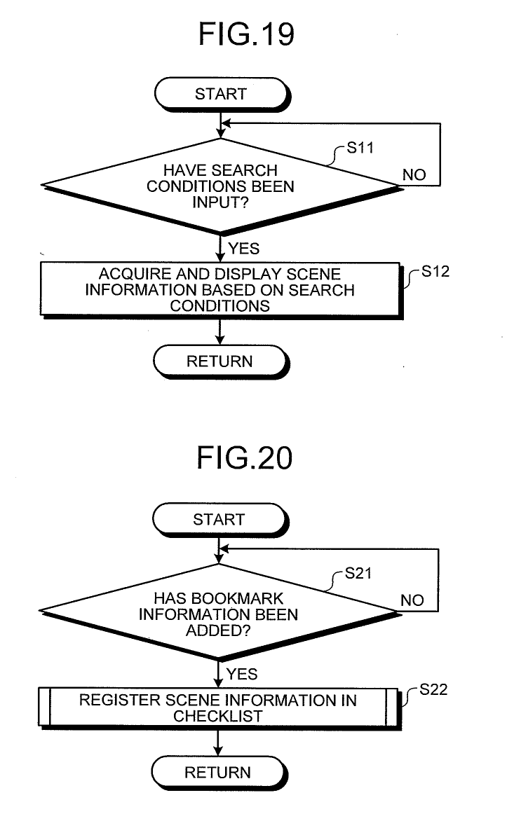

The following describes the search processing executed by the information terminal 100 with reference to FIG. 19.

In the processing flow illustrated in FIG. 19, the arithmetic processor 55 determines whether search conditions have been input at S11. In other words, the arithmetic processor 55 determines whether the input controller 51 has detected an operation to specify the search conditions such as keywords and genres by use of the search bar B2 and the selection buttons B3 to B7 in FIGS. 4A and 4B. The processing of S11 is repeated until the search conditions are determined to have been input. If the search conditions are determined to have been input at S11, the processing goes to S12.

At S12, based on the input search conditions, the communication controller 53 acquires scene information corresponding to the search conditions and the output controller 52 displays the acquired scene information on the display 11. This processing causes the screen IM2 in FIG. 5, the screen IM6 in FIG. 10, the screen IM9 in FIG. 13, and the screen IM10 in FIG. 14, for example, to be displayed on the display 11. Then the processing returns.

The following describes the processing executed by the information terminal 100 when the bookmark information is added with reference to FIG. 20.

In the processing flow illustrated in FIG. 20, the arithmetic processor 55 determines whether the bookmark information has been added at S21. In other words, the arithmetic processor 55 determines whether the input controller 51 has detected an operation of adding the bookmark information by use of the image IM13b on the screen IM13 in FIG. 17. The processing of S21 is repeated until the bookmark information is determined to have been added. If the bookmark information is determined to have been added at S21, the processing goes to S22.

At S22, based on the added bookmark information, the communication controller 53 acquires scene information corresponding to the bookmark information from the program information server 300. The detail about this processing of S22 will be described below. Then the processing returns.

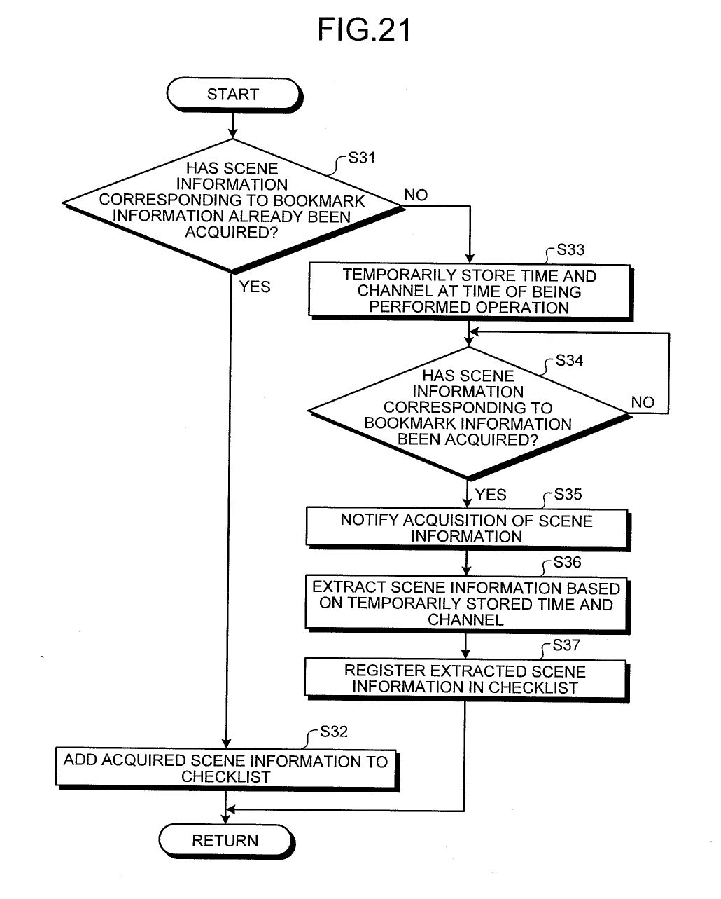

The following describes the processing executed by the information terminal 100 when the scene information is registered in the checklist, in other words, the detail about the processing of S22 in FIG. 20 with reference to FIG. 21.

In the processing flow illustrated in FIG. 21, the arithmetic processor 55 determines whether the scene information corresponding to the bookmark information added at S21 in FIG. 20 has been acquired from the program information server 300 at S31. For example, if the communication controller 53 is configured to regularly acquire program information from the program information server 300, the arithmetic processor 55 determines whether the scene information corresponding to the bookmark information is included in the regularly acquired program information.

If the scene information corresponding to the bookmark information is determined to have been acquired at S31, in other words, if a program displayed and played at the time of being performed the operation of adding the bookmark information is the recorded program which is recorded in the past, the processing goes to S32. At S32, the checklist manager 54 registers the acquired scene information corresponding to the bookmark information in the checklist. Then the processing returns.

If the scene information corresponding to the bookmark information is determined to have not been acquired at S31, in other words, if a program displayed and played at the time of being performed the operation of adding the bookmark information is the currently broadcasting program, the processing goes to S33. At S33, the arithmetic processor 55 temporarily stores a time and a channel of the program displayed and played at the time of being performed the operation of adding the bookmark information. Then the processing goes to S34.

At S34, the arithmetic processor 55 determines whether the scene information corresponding to the bookmark information has been acquired from the program information server 300. In other words, if the communication controller 53 is configured to regularly acquire program information from the program information server 300, the arithmetic processor 55 determines whether the scene information of the scene specified based on the channel and the time stored as the bookmark information is included in the regularly acquired program information.

The processing of S34 is repeated until the scene information corresponding to the bookmark information is determined to be acquired. If the scene information corresponding to the bookmark information is determined to be acquired at S34, the processing goes to S35.

At S35, the arithmetic processor 55 notifies a user of the acquisition of the scene information corresponding to the bookmark information through the output controller 52. Then the processing goes to S36.

At S36, based on the time and the channel temporarily stored at S33, the arithmetic processor 55 extracts the scene information corresponding to the bookmark information from the acquired program information. Then the processing goes to S37.

At S37, the checklist manager 54 registers the scene information extracted at S36 in the checklist. Then the processing returns.

As described above, in the embodiment, the controller 15 is configured, by executing the information processing program 500, to acquire the scene information and the item service information from the program information server 300, to receive the operation of specifying specifies the item or service by a user, and to display the scene information relating to one or more scenes that introduce the specified item or service on the display 11 in response to the received operation. Thus, the information relating to the program that introduces the item or service specified by a user can be finely searched, for example, in scene units.

In the embodiment, if one scene included in a program is being viewed and an operation for registering scene information relating to the currently viewed scene is performed after the acquisition of the program information from the program information server 300, the controller 15 is configured to register the scene information relating to the currently viewed scene in the checklist by use of the acquired program information. Thus, by performing a predetermined operation while a program including program information that has already been acquired, for example, a recorded program is viewed, the scene information relating to the scene specified by a user in the program can be stored in the checklist.

In the embodiment, if one scene in a program is being viewed and an operation for registering information of the currently viewed scene is performed before the acquisition of the program information, the controller 15 is configured to temporarily store the time and the channel of the currently viewed scene, to acquire the program information, and to extract scene information relating to the currently viewed scene from the acquired program information by use of the temporarily stored time and the channel so that the extracted scene information is registered in the checklist. Thus, by performing a predetermined operation while a program including program information that has not been acquired yet, for example, the currently broadcasting program is viewed, the scene information relating to the scene specified by a user in the program can be stored in the checklist.

In the embodiment, when receiving the program information and then extracting the scene information by use of the broadcast time and the channel of the currently viewed scene to register the extracted scene information in the checklist, the controller 15 is configured to display on the display 11 an image (image IM13b in FIG. 17) that is used for allowing a user to select the information catching the user's interest and relating to the currently viewed scene. Thus, what information caught the user's interest and prompted the user to register the scene in the checklist can be specified, thereby the information corresponding to the user's interest can be provided to the user as recommended information.

In the embodiment, when an operation for viewing the scene information relating to one or more scenes registered in the checklist is performed, the controller 15 is configured to display the scene information relating to the scenes registered in the checklist and the item service information relating to the items or services introduced in the registered scenes on the display 11. Thus, the scene information and the item service information in which a user is interested can be associated with each other and displayed based on the checklist.

The information processing program 500 in the embodiment is provided as a computer program product in an installable or executable format. In other words, the information processing program 500 is provided, included in a computer program product having a non-transitory and computer-readable storage medium such as compact disc read-only memory (CD-ROM), a flexible disk (FD), compact disc-recordable (CD-R), and a digital versatile disc (DVD).

The information processing program 500 may be provided or distributed through a network, stored in a computer connected to a network such as the Internet. The information processing program 500 may be provided, preliminarily embedded in read-only memory (ROM) and the like.

In the above-mentioned embodiment, the information terminal 100 is configured to execute the processing for searching for scene information based on the item or service specified by a user. However, the above-mentioned search processing may be executed by the television device 200. In other words, in the embodiment, a program having the same function as that of the information processing program 500 may be installed in the television device 200 and the above-mentioned search processing may be executed by the television device 200. In the above-mentioned embodiment, the search conditions are specified by touch input, but they may be specified by voice input.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method, comprising:
receiving first information and second information by an electronic device, the first information relating to first scenes in a first program and comprising information of one or more goods or services introduced in at least one of the first scenes, the second information relating to second scenes in a second program and comprising information of one or more goods or services introduced in at least one of the second scenes;
receiving a first operation to specify a first good or a first service; and
displaying information relating to one or more third scenes searched from the first scenes and the second scenes on a display in response to the first operation, the one or more third scenes introducing the specified first good or first service.

2. The method of claim 1, further comprising:
registering, when one first scene in the first program is being viewed and a second operation for registering information of the one first scene is performed after the reception of the first information, at least a part of the information of the one first scene in a first list by use of the first information.

3. The method of claim 1, further comprising:
temporarily storing, when one first scene in the first program is being viewed and a second operation for registering information of the one first scene is performed before the reception of the first information, at least a broadcast time and a channel of the one first scene;
extracting at least a part of information of the one first scene from the first information by use of the broadcast time and the channel after a reception of the first information; and
registering the at least a part of information of the one first scene in a first list.

4. The method of claim 3, further comprising:
displaying, when extracting the at least a part of information of the one first scene from the first information by use of the broadcast time and the channel and registering the at least a part of information of the one first scene in the first list, an image used for allowing a user to select information in which the user is interested out of the information of the one first scene on the display.

5. The method of claim 1, further comprising:
registering, when a third operation for registering information of one first scene in the first program is performed, the information of the one first scene in a first list by use of the first information;
registering, when a third operation for registering information of one second scene in the second program is performed, the information of the one second scene in the first list by use of the second information; and
displaying, when a fourth operation for viewing information of one or more fourth scenes registered in the first list is performed, information of the one or more fourth scenes comprising at least information of the one or more items or one or more services introduced in each of the one or more fourth scenes.

6. An electronic device, comprising circuitry configured to:
receive first information and second information by an electronic device, the first information relating to first scenes in a first program and comprising information of one or more goods or services introduced in at least one of the first scenes, the second information relating to second scenes in a second program and comprising information of one or more goods or services introduced in at least one of the second scenes;
receive a first operation to specify a first good or a first service; and
display information relating to one or more third scenes searched from the first scenes and the second scenes on a display in response to the first operation, the one or more third scenes introducing the specified first good or first service.

7. The electronic device of claim 6, wherein the circuitry is further configured to:
register, when one first scene in the first program is being viewed and a second operation for registering information of the one first scene is performed after the reception of the first information, at least a part of the information of the one first scene in a first list by use of the first information.

8. The electronic device of claim 6, wherein the circuitry is further configured to:
temporarily store, when one first scene in the first program is being viewed and a second operation for registering information of the one first scene is performed before the reception of the first information, at least a broadcast time and a channel of the one first scene;
extract at least apart of information of the one first scene from the first information by use of the broadcast time and the channel after a reception of the first information; and
register the at least a part of information of the one first scene in a first list.

9. The electronic device of claim 8, wherein the circuitry is further configured to:
display, when extracting the at least a part of information of the one first scene from the first information by use of the broadcast time and the channel and registering the at least apart of information of the one first scene in the first list, an image used to select information of the one first scene on the display.

10. The electronic device of claim 6, wherein the circuitry is further configured to:
register, when a third operation for registering information of one first scene in the first program is performed, the information of the first scene in a first list by use of the first information;
register, when a third operation for registering information of one second scene in the second program is performed, the information of the second scene in the first list by use of the second information; and
display, when a fourth operation for viewing information of one or more fourth scenes registered in the first list is performed, information of the one or more fourth scenes comprising at least information of one or more items or one or more services introduced in each of the one or more fourth scenes.

11. A computer program product having a non-transitory computer readable medium including programmed instructions, wherein the instructions, when executed by a computer, cause the computer to perform:
receiving first information and second information by an electronic device, the first information relating to first scenes in a first program and comprising information of one or more goods or services introduced in at least one of the first scenes, the second information relating to second scenes in a second program and comprising information of one or more goods or services introduced in at least one of the second scenes;
receiving a first operation to specify a first good or a first service; and
displaying information relating to one or more third scenes searched from the first scenes and the second scenes on a display in response to the first operation, the one or more third scenes introducing the specified first good or first service.

12. The computer program product of claim 11, wherein the instructions cause the computer to further perform:
registering, when one first scene in the first program is being viewed and a second operation for registering information of the one first scene is performed after the reception of the first information, at least a part of the information of the one first scene in a first list by use of the first information.

13. The computer program product of claim 11, wherein the instructions cause the computer to further perform:
temporarily storing, when one first scene in the first program is being viewed and a second operation for registering information of the one first scene is performed before the reception of the first information, at least a broadcast time and a channel of the one first scene;
extracting at least a part of information of the one first scene from the first information by use of the broadcast time and the channel after a reception of the first information; and
registering the at least a part of information of the one first scene in a first list.

14. The computer program product of claim 13, wherein the instructions cause the computer to further perform:
displaying, when extracting the at least a part of information of the one first scene from the first information by use of the broadcast time and the channel and registering the at least a part of information of the one first scene in the first list, an image used to select information of the one first scene on the display.

15. The computer program product of claim 11, wherein the instructions cause the computer to further perform:
registering, when a third operation for registering information of one first scene in the first program is performed, the information of the one first scene in a first list by use of the first information;
registering, when a third operation for registering information of one second scene in the second program is performed, the information of the second scene in the first list by use of the second information; and
displaying, when a fourth operation for viewing information of one or more fourth scenes registered in the first list is performed, information of the one or more fourth scenes comprising at least information of one or more items or one or more services introduced in each of the one or more fourth scene.
